(19) United States
(12) Patent Application Publication
(10) Pub. No.: US 2008/0161204 A1
(43) Pub. Date: Jul. 3, 2008

(54) MICROWELL ARRAY FOR PARALLEL SYNTHESIS OF CHAIN MOLECULES

(76) Inventors: Mo-Huang Li, Singapore (SG); Franco Cerrina, Madison, WI (US); James Howard Kaysen, Madison, WI (US)

Correspondence Address: FOLEY & LARDNER LLP, 150 EAST GILMAN STREET, P.O. BOX 1497, MADISON, WI, 53701-1497, US

(21) Appl. No.: 11/868,227

(22) Filed: Oct. 5, 2007

Related U.S. Application Data
(60) Provisional application No. 60/850,232, filed on Oct. 6, 2006.

(51) Int. Cl. C40B 50/14; C40B 60/14

(52) U.S. Cl. 506/30; 506/40

(57) ABSTRACT

The present invention provides a substrate, system and method for synthesizing chain molecules in parallel using light-directed chemistry by imaging a selected pattern of light onto a dense array of microwells extending into a substrate surface, wherein the microwells are packed with high-surface-area carrier particles on which the chain molecules are grown in a series of sequential photoinitiated chemical steps.

### CROSS-REFERENCE TO RELATED APPLICATIONS

This application claims the benefit of U.S. Provisional Patent Application Ser. No. 60/850,232 filed Oct. 6, 2006, the entire disclosure of which is incorporated by reference.

### STATEMENT OF GOVERNMENT RIGHTS

This invention was made with United States government support awarded by Defense Advanced Research Projects Agency (DARPA) under Grant No. N39998-01-2-7070. The United States federal government has certain rights in this invention.

### FIELD OF THE INVENTION

This invention pertains generally to the field of biology, and particularly to substrates and apparatus for the synthesis, analysis, and sequencing of chain molecules, such as oligonucleotides, peptides, and other polymers.

### BACKGROUND OF THE INVENTION

The de-novo synthesis of DNA opens new vistas in many areas of biology, where synthetic DNA can be used to activate expression in cells, create or repair genes, and even enable “intelligent scaffolds” for the creation of artificial nanostructures. The de-novo synthesis of DNA enables the nascent field of Synthetic Biology, and its vast applications to medicine, biology, energy, and the environment. However, the synthesis of DNA is plagued by technical difficulties. It is not possible to synthesize very long constructs, in the thousands of bases, by direct extension of one base at a time. Typically, it is preferable to use a hierarchical assembly process, whereby short segments of DNA are assembled in progressively longer constructs, until the final product is achieved. Hence, the input to the synthesis process is a collection of short fragments, typically 40-70 nucleotides long, that are the initial “building blocks.” Hence, a 10,000-base-pair (bp) gene will require 500 different 40-nucleotide “starting oligos.” Today, these oligomers (henceforth called “oligos”) are synthesized by traditional phosphoramidite chemistry. This process is efficient, and produces good quality oligos, but is by its nature limited to be a serial process, in which each reaction takes place in a separate vessel and yields one oligo per vessel. In a hierarchical scheme, it is preferable to have available a parallel synthesis process, whereby all of the starting oligos are synthesized at once. Several such parallel synthesis methods exist, but those based on the use of photolithographic exposures yield by far the largest number of different oligos per synthesis. One such approach for generating an array of oligonucleotide probes synthesized by photolithographic techniques is described in Pease, et al., “Light-Generated Oligonucleotide Arrays for Rapid DNA Sequence Analysis,” Proc. Natl. Acad. Sci. USA, Vol. 91, pp. 5022-5026, May 1994. In this approach, the surface of a solid support modified with photolabile protecting groups is illuminated through a photolithographic mask, yielding reactive hydroxyl groups in the illuminated regions. A 3′ activated deoxynucleoside, protected at the 5′ hydroxyl with a photolabile group, is then provided to the surface such that coupling occurs at sites that have been exposed to light. Following capping and oxidation, the substrate is rinsed and the surface is illuminated through a second mask to expose additional hydroxyl groups for coupling. A second 5′ protected activated deoxynucleoside base is presented to the surface. The selective photodeprotection and coupling cycles are repeated to build up levels of bases until the desired set of probes is obtained. It may be possible to generate high-density miniaturized arrays of oligonucleotide probes using such photolithographic techniques, wherein the sequence of the oligonucleotide probe at each site in the array is known. These probes can then be used to search for complementary sequences on a target strand of DNA, by using fluorescent markers coupled to the targets and inspection by an appropriate fluorescence scanning microscope to detect the target that has hybridized to particular probes. A variation of this process using polymeric semiconductor photoresists that are selectively patterned by photolithographic techniques, rather than using photolabile 5′ protecting groups, is described in McGall, et al., “Light-Directed Synthesis of High-Density Oligonucleotide Arrays Using Semiconductor Photoresists,” Proc. Natl. Acad. Sci. USA, Vol. 93, pp. 13555-13560, November 1996, and G. H. McGall, et al., “The Efficiency of Light- Directed Synthesis of DNA Arrays on Glass Substrates,” Journal of the American Chemical Society 119, No. 22, 1997, pp. 5081-5090.

A disadvantage of both of these approaches is that four different lithographic masks are needed for each monomeric base, and the total number of different masks required is thus four times the length of the DNA probe sequences to be synthesized. The high cost of producing the many precision photolithographic masks that are required, and the multiple processing steps required to reposition the masks for every exposure, contribute to relatively high costs and lengthy processing times.

Other techniques have been developed for the creation of arrays of probe sequences, polypeptides, and other large chain molecules using patterning processes that do not require multiple masks. See U.S. Pat. No. 6,375,903, and published U.S. Patent Application Publication Nos. 2003/0068633, 2003/0143132, 2003/0143550, 2003/0143724, 2003/0148502, 2004/0126757, and 2004/0132029, which are incorporated herein by reference. However, the synthesis of oligomers in the production of high-density microarrays in these systems is typically carried out on flat glass substrates. This limits their application to the synthesis of de-novo DNA because of the small amounts of material generated on a flat surface, on the order of 20 picoMol/cm . When divided among 1000 different sequences, the resulting 20 femtoMol per sequence is insufficient for an effective preparation. An effective solution is to carry out the synthesis on a substrate with a very high specific area. Many different kinds of surfaces may exhibit a specific surface area well in excess of the geometrical “flat” area. Typical examples of such substrates include gels, aerogels, sponges, and porous and micro- or nano-structured materials. Particularly interesting is synthesis on “controlled porosity glass” (CPG) beads. These glass beads, typically formed by etching a two-phase glass bead, have exceptionally high surface areas. Thus, a CPG bead may have a surface area thousands of times greater than its geometrical surface area. The challenge is to determine how to direct the light onto the beads, while keeping them separate from each other and confined to a single location.

### SUMMARY OF THE INVENTION

In accordance with the present invention, the synthesis of arrays of chain molecules, including DNA probe sequences, polypeptides, synthetic polymers, and the like is carried out rapidly and efficiently using an optical patterning process on a substrate composed of an array of microwells, each of which contains a few (e.g., <5), and preferably only one, high-surface-area carrier particle(s) on which chain molecules may be synthesized.

The process may be automated and computer-controlled to allow the fabrication of chain molecules customized to a particular investigation. No lithographic masks are required, thus eliminating the significant costs and time delays associated with the production of lithographic masks and avoiding time-consuming manipulation and alignment of multiple masks during the fabrication process.

One aspect of the present invention provides a substrate which defines an array of microwells, each of which contains one (or a couple or a few) carrier particles. The carrier particles are made from, or coated with, a material that acts as a linker between the surface of the particle and the chain molecule to be formed. The surface or coating of the carrier molecules is desirably initially terminated with protected functional groups in order to prevent premature or unwanted reactions with the carrier particle surfaces.

To begin the process of building chain molecules on the surfaces of the carrier particles in the microwells, a high-precision, two-dimensional light image is projected onto the substrate surface, such that it is aligned with the pattern of microwells in the array, illuminating those microwells in the array which are to be activated to bind a first unit, or “building block,” of the chain molecule. For example, if the chain molecule being fabricated is an oligonucleotide, the first unit may be a nucleotide base. Functional groups on the surfaces of the carrier particles in the microwells which are illuminated by the light image are activated by the light, rendering the carrier particles reactive toward a chain building block molecule, such as a nucleic acid, an amino acid, a monomer, or an oligomer. For example, the surfaces of the carrier particles may be functionalized with protected -OH groups which are deprotected by the light, making them available for binding to bases. After the carrier particles have been selectively activated by the light image, the microwell array is exposed to a fluid containing an appropriate building block molecule which then binds to the activated carrier particles. The building block molecules bound on the particles are themselves desirably protected, and a new light image is then projected onto the microwell array to activate the carrier particles and/or their surface-bound building block molecules. These newly activated carrier particles are then exposed to a solution containing a newly selected building block molecule which binds to the activated carrier particle surface or to the deprotected building block molecules that are already bound to the carrier particles. The process may then be repeated to bind other building block molecules to selected carrier particles, until all of the desired chain molecules have been fabricated on the appropriate carrier particles.

The carrier particles are typically spherical or generally spherical, but may be formed in shapes other than spheres; for example, as cylinders, fibers, or irregular shapes with smooth or structured surfaces. The carrier particles may be made from a variety of materials, including quartz, glass, plastics, and metals. For example, the carrier particles may be formed of CPG or similar porous materials which provide a large surface area-to-mass ratio. CPG is well-suited for use in the present systems due to its high surface area. For example, a CPG bead with a diameter of 100 microns and a pore size of 500 angstroms has a surface area greater than 1 cm². Thus, using the present methods, one CPG bead can synthesize up to approximately 20 pmole of oligomer. The largest cross-sectional diameter of the carrier particles is desirably no more than about 1,000 microns (e.g., about 1 to 100; about 1 to 1,000; or about 1 to 5,000 microns), although larger particles may also be used.

The array of microwells is typically, but not necessarily, a regular array. The dimensions and density of the microwells depends, at least in part, on the particular application in which the chain molecules are to be utilized. However, the microwells typically have a volume of no more than about 100 nL (e.g., no more than about 50 nL, no more than about 20 nL, or no more than about 10 nL), and may be in the shape of an inverted pyramid. For example, the density of microwells on the surface of a substrate may be at least 500 microwells per cm². This includes embodiments where the density of microwells is at least about 1,000 microwells per cm² and further includes embodiments where the density of microwells is at least about 1,500 microwells per cm². The aperture that defines the top opening of each microwell is designed to have a diameter large enough to allow carrier particles of the desired size to fit into the microwells, while preventing larger particles from entering the microwells. The microwells desirably have an aperture in their bottom surface in order to allow reagents to pass through the microwells. This aperture has a diameter that is smaller than the dimensions of the carrier particle(s) to be held in the microwell, such that the carrier particle(s) cannot escape the microwell through this bottom aperture. The bottom aperture may be formed by etching oppositely facing pyramidal pits (i.e., microwells) into the opposing faces of a thin substrate such that the tips of the pyramids meet to create the bottom aperture. In some embodiments, the bottom aperture is coated with a hydrophobic material, such as Teflon, in order to constrain the flow of reagents through that aperture.

The light image may be projected onto a microwell array using any suitable system. The system may, for example, comprise a light source, providing a light beam and a micromirror device receiving the light beam which is formed of an array of electronically addressable micromirrors. Each of the micromirrors can be tilted between one of at least two positions, wherein in one of the positions of the micromirror light from the source is deflected away from an optical axis and in the second of the positions light is reflected along the optical axis. Descriptions of suitable micromirror array systems may be found in U.S. Pat. No. 6,375,903, the entire disclosure of which is incorporated herein by reference. Other types of spatial light modulators may be used, rather than micromirror array-based systems. Projection optics may be used to direct the light image onto the microwell array.

The substrate may be mounted within a flow cell, with an enclosure sealing off the microwell array, allowing the appropriate reagents to flow through the flow cell and over the microwell array in the appropriate sequence to build up the chain molecules on the carrier particles held in the microwells.

Further objects, features, and advantages of the invention will be apparent from the following detailed description when taken in conjunction with the accompanying drawings.

### BRIEF DESCRIPTION OF THE DRAWINGS

FIG. 1 is a schematic top view of a microwell in a silicon substrate.

FIG. 2 is a cross-sectional view of a microwell in a silicon substrate.

FIG. 3 is a schematic view of a microwell array in a flow cell.

FIG. 4 is a schematic view of a micromirror array-based spatial light modulator that may be used to project a light image onto a microwell array.

FIG. 5 is a schematic view of another micromirror array-based spatial light modulator that may be used to project a light image onto a microwell array.

### DETAILED DESCRIPTION OF THE INVENTION

One aspect of the present invention provides a system for synthesizing chain molecules in parallel using light-directed chemistry by imaging a selected pattern of light on dense arrays of microwells extending into a substrate surface, wherein the microwells are packed with high-surface-area carrier particles on which the chain molecules are grown in a series of sequential photochemical steps. The system is capable of providing massive parallel synthesis of a large number of different chain molecules on a small substrate surface area in a short period of time. For example, the system may be used for the parallel synthesis of greater than 2,000 oligomers having different nucleic acid sequences on a silicon chip with a surface area of 2-2.5 cm² in less than 10 hours.

The dense array of microwells is packed with small carrier particles (e.g., CPG beads). The dimensions of the microwells are optimized so that only one carrier particle (or a couple or a few microparticles) with a desired diameter is trapped inside each microwell. Using this substrate to build chain molecules on carrier particles isolated in small wells minimizes the reaction volume and saves potentially expensive reagents. In addition, the isolated microwells serve the dual functions of providing isolated synthesis locations and confining the light, which reduces the light interference between neighboring microwells.

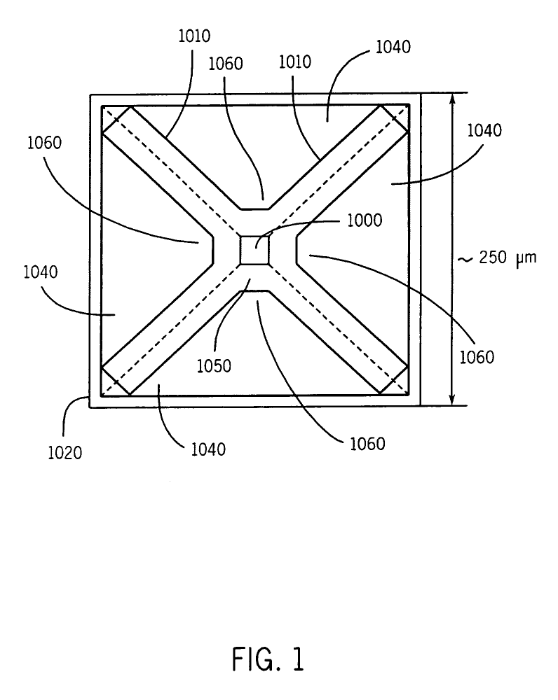

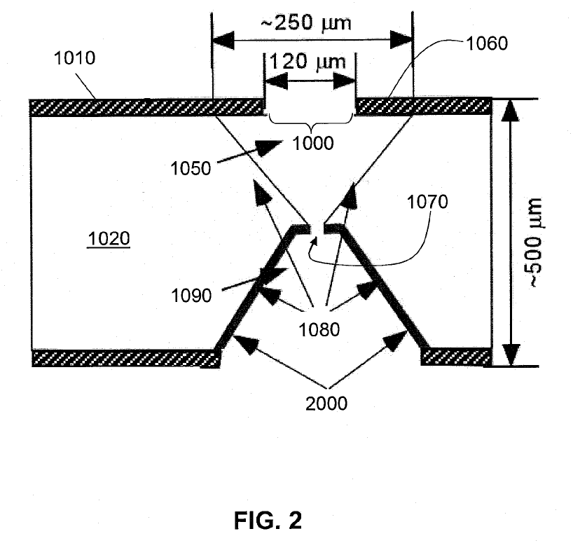

FIG. 1 shows a schematic illustration of the structure of a microwell extending into a semiconductor substrate. An array of microwells, of the type shown in FIG. 1, may be formed by etching a substrate using an appropriate mask. For example, a microwell may be created by using the anisotropic wet etching properties of a silicon (Si) wafer, such that the structure of the microwell is defined by the crystal directions of the Si substrate. The etch rate ratio of Si in the <111> direction and in the <100> direction is about 1 to 400. Therefore, when a (100) wafer with a protected surface (e.g., a 1-micron-thick Si₃N₄ layer or an SiO₂ layer) that defines an array of small openings is immersed in an etch solution (e.g., a KOH solution), etch pits in the form of a regular inverted pyramid (the well) will be created where the substrate is exposed to the etchant through the openings in the protective layer. The lateral size and arrangement of the microwells are defined by the thin protective layer. Provided the protective layer is chosen such that it has a negligible etch rate in the etch solution the lateral dimensions of the microwells may be essentially independent of the shape of the openings in the protective layer. This is illustrated in FIGS. 1 and 2, which show a single opening 1000 in a protective Si₃N₄ etch mask 1010 over an Si (100) wafer 1020. Here, the opening is in the form of a cross, defined by four flaps 1040 of the etch mask. The shape of the pit (i.e., the microwell) 1050 formed by etching through the etch mask is defined by the four (111) surfaces of the Si substrate and the diagonal diameter of the cross. Since the mask is not etched, but is undercut during the etching process, the four flaps will become four suspended leaves 1060 after microwell etching. This is best shown in FIG. 2. The opening at the top of each microwell essentially serves as a carrier particle size filter. In the embodiment depicted in FIG. 2, the suspended leaves provide flexible edges at the opening of the microwell, such that an appropriately sized carrier particle may fit through the opening.

The microwell of FIG. 2 also has a bottom aperture 1070, the size of which is fixed by the slope of the tapering microwell walls 1080 and the size of the top opening 1000. Thus, only carrier particles with dimensions smaller than the top opening and bigger than the bottom aperture will be trapped in the microwell. The bottom aperture may be formed by etching the Si wafer from opposing surfaces as shown in FIG. 2. The intersection of the two opposing microwells 1050 and 1090 will define the diameter of the lower aperture 1070. Although the microwells in FIG. 2 are represented by regular pyramids, the shape of the microwells is not limited to regular pyramids. If necessary, a different shape for the wells can be created by combining deep reactive ion etching (DRIE) and KOH wet etching technologies. However, because the sloped walls of a pyramidal microwell act as light concentrators, they are well suited for the present application.

To confine the reagents more effectively inside the microwells and to improve the uniformity of reagent delivery, the bottom apertures of the microwells can be coated with hydrophobic material 2000, such as Teflon, as shown in FIG. 2. The surface tension force at the hydrophobic neck provided by the lower aperture helps to constrain the flow of reagents out of the microwells. For example, if the reagent pumping force is kept lower than the surface tension force at the aperture, a reagent will fill up the microwells before being released through the apertures. This provides a uniform fluidic flow that does not depend on the number and dimensions of the microwells.

Once the microwell array has been fabricated, the carrier particles may be packed into the microwells and chain molecules may be grown on the carrier particles in the microwells using a series of photochemical reactions governed by a light image forming apparatus. For example, the fabrication of oligomers may be carried out using photoinitiated phosphoramidite chemistry.

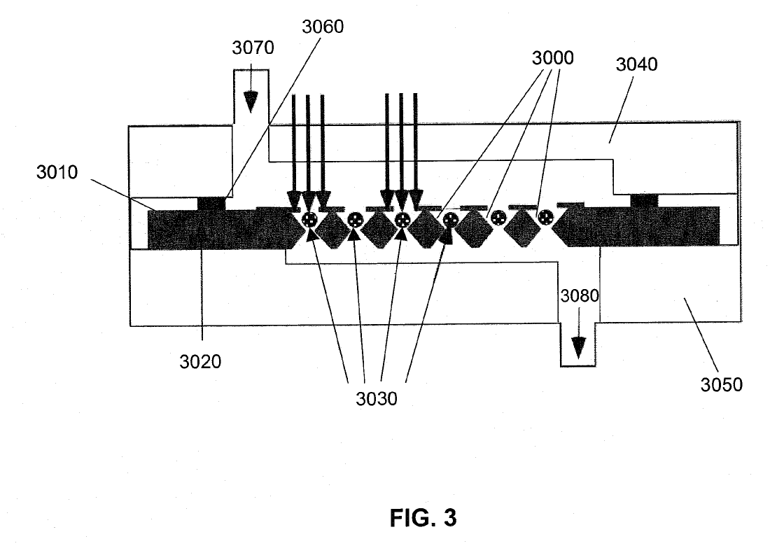

FIG. 3 is a schematic cross-sectional view of an array of microwells housed in a flow cell. The microwells 3000 extend into the surface 3010 of an Si wafer 3020, and each microwell contains a single carrier particle 3030. In the flow cell, the Si wafer 3020 is sandwiched between an upper plate 3040 and a lower plate 3050 using a gasket 3060 to form a sealed reaction chamber. At least one of the upper and lower plates is transparent, such that a light image may be directed onto the microwell array through that plate. The flow cell further includes an inlet port 3070 for introducing reagents into the flow cell and an outlet port 3080 for expelling reagents from the flow cell after they have passed through the microwells.

After fabrication of the chain molecules on the carrier particles is completed, the chain molecules may be released from their respective carrier particles and eluted in parallel into a conventional microwell chip using a standard release protocol. The released chain molecules may then be transferred to a microtiter plate using an appropriate adapter plate. Notably, because the volume of the microwells is typically quite small (e.g., 15 nL or less), it may be possible to carry out subsequent assays using the released chain molecules without the need for further concentrating steps.

By way of illustration, the fabrication of oligomers on the carrier particles may be carried out as follows. A light image is projected onto and aligned with the microwell array and photodeprotecting groups on the carrier particles in the illuminated microwells are removed. A reagent containing a selected base (e.g., adenine (A)) is flowed through the flow cells, and the base attaches to the carrier particles in those sections that have been exposed to light and deprotected. A reagent containing a protecting group may then be flowed through the flow cell to protect the oligomers. A second light image is then projected onto the microwell array to photodeprotect selected carrier particles and/or carrier particle-bound nucleic acids or oligomers, followed by flowing another base (e.g., guanine (G)) over the microwell array where it will bind to the photodeprotected groups. The process can be repeated multiple times to form a desired sequence of bases on each of the carrier particles in the microwells. After completion of the synthesis, the oligomers can be eluted by flowing a reagent through the flow cell, which detaches all of the oligomers from the carrier particles using, for example, a hot ammonium hydroxide solution. In addition, selected oligomers can be removed by utilizing photolabile attachment of the oligomers to the carrier particles so that a single oligomer sequence or several selected sequences can be removed by appropriate illumination of selected microwells.

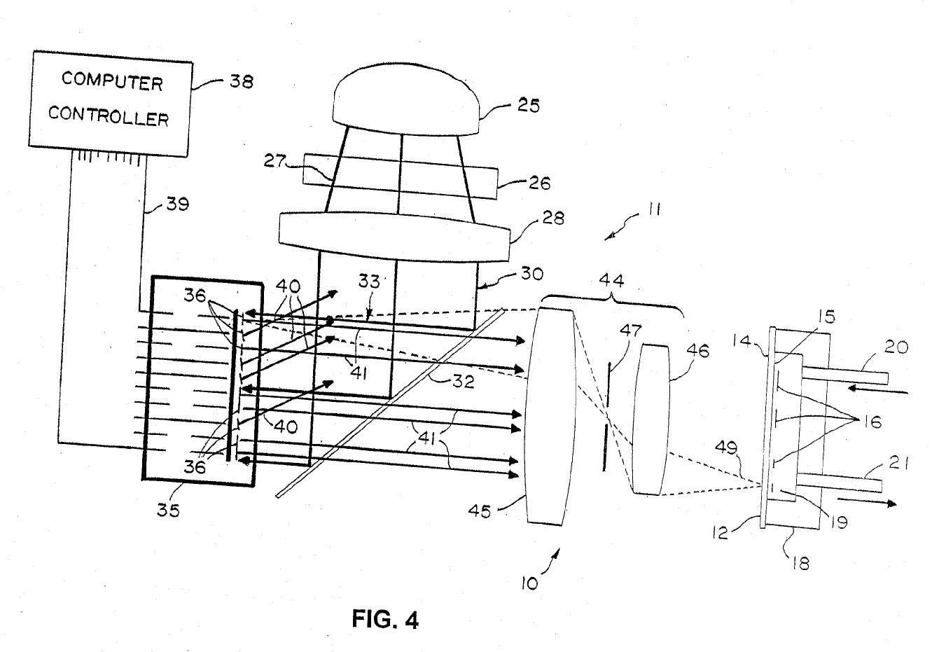

With reference to the drawings, an exemplary apparatus that may be used for chain molecule synthesis, polypeptide synthesis, polymer synthesis, and the like is shown at 10 in FIG. 4 and includes a two-dimensional array image former 11 and a substrate 12 onto which a light image is projected by the image former 11. For the configuration shown in FIG. 4, the substrate has an upper surface 14 and an oppositely-facing lower surface 15 which defines an array of microwells (not shown). For purposes of illustration, the substrate 12 is shown in the figure with a flow cell enclosure 18 mounted to the substrate 12 enclosing a volume 19 into which reagents can be provided through an input port 20 and an output port 21. However, the substrate 12 may be utilized in the present system with surface 15 of the substrate facing the image former 11 and enclosed within a reaction chamber flow cell with a transparent window to allow light to be projected onto the microwell array. The invention may also use an opaque or porous substrate. If the chain molecules to be formed are oligonucleotides, the reagents may be provided to the ports 20 and 21 from a conventional base synthesizer (not shown).

The image former 11 includes a light source 25 (e.g., an ultraviolet or near ultraviolet source such as a mercury arc lamp), an optional filter 26 to receive the output beam 27 from the source 25 and selectively pass only the desired wavelengths (e.g., the 365 nm Hg line), and a condenser lens 28 for forming a collimated beam 30. Other devices for filtering or monochromating the source light, e.g., diffraction gratings, dichroic mirrors, and prisms, may also be used rather than a transmission filter, and are generically referred to as “filters” herein. The beam 30 is projected onto a beam splitter 32 which reflects a portion of the beam 30 into a beam 33 which is projected onto a two-dimensional micromirror array device 35. The micromirror array device 35 has a two-dimensional array of individual micromirrors 36 which are each responsive to control signals supplied to the array device 35 to tilt in one of at least two directions. Control signals are provided from a computer controller 38 on control lines 39 to the micromirror array device 35. The micromirrors 36 are constructed so that in a first position of the mirrors the portion of the incoming beam of light 33 that strikes an individual micromirror 36 is deflected in a direction oblique to the incoming beam 33, as indicated by the arrows 40. In a second position of the mirrors 36, the light from the beam 33 striking such mirrors in such second position is reflected back parallel to the beam 33, as indicated by the arrows 41. The light reflected from each of the mirrors 36 constitutes an individual beam 41. The multiple beams 41 are incident upon the beam splitter 32 and pass through the beam splitter with reduced intensity, and are then incident upon projection optics 44 comprised of, e.g., lenses 45 and 46 and an adjustable iris 47. The projection optics 44 serve to form an image of the pattern of the micromirror array 35, as represented by the individual beams 41 (and the dark areas between these beams), on the surface 15 of the substrate 12. The outgoing beams 41 are directed along a main optical axis of the image former 11 that extends between the micromirror device and the substrate. The substrate 12 in the configuration shown in FIG. 4 is transparent, e.g., formed of fused silica or soda lime glass or quartz, so that the light projected thereon, illustratively represented by the lines labeled 49, passes through the substrate 12 without substantial attenuation or diffusion.

A preferred micromirror array 35 is the Digital Micromirror Device (DMD) available commercially from Texas Instruments, Inc. These devices have arrays of micromirrors (each of which is substantially square, with edges of 10 to 20 μm in length) that are capable of forming patterned beams of light by electronically addressing the micromirrors in the arrays. Such DMD devices are typically used for video projection and are available in various array sizes, e.g., 640×800 micromirror elements (512,000 pixels), 640×480 (VGA; 307,200 pixels), 800×600 (SVGA; 480,000 pixels); and 1024×768 (786,432 pixels). Such arrays are discussed in the following article and patents: Larry J. Hornbeck, “Digital Light Processing and MEMs: Reflecting the Digital Display Needs of the Networked Society,” SPIE/EOS European Symposium on Lasers, Optics, and Vision for Productivity and Manufacturing I, Besancon, France, Jun. 10-14, 1996; and U.S. Pat. Nos. 5,096,279, 5,535,047, 5,583,688 and 5,600,383. The micromirrors 36 of such devices are capable of reflecting the light of normal usable wavelengths, including ultraviolet and near ultraviolet light, in an efficient manner without damage to the mirrors themselves.

The window of the enclosure for the micromirror array preferably has anti-reflective coatings thereon optimized for the wavelengths of light being used. Utilizing commercially available 600×800 arrays of micromirrors, encoding 480,000 pixels, with typical micromirror device dimensions of 16 microns per mirror side and a pitch in the array of 17 microns, provides total micromirror array dimensions of 13,600 microns by 10,200 microns. By using a reduction factor of 5 through the optics system 44, a typical and readily achievable value for a lithographic lens, the dimensions of the image projected onto the substrate 12 are thus about 2,220 microns by 2,040 microns, with a resolution of about 2 microns. Larger images can be exposed on the substrate 12 by utilizing multiple side-by-side exposures (by either stepping the flow cell 18 or the image projector 11), or by using a larger micromirror array. It is also possible to do one-to-one imaging without reduction, as well as enlargement of the image on the substrate, if desired.

The projection optics 44 may be of standard design, since the images to be formed are relatively large and well away from the diffraction limit. The lenses 45 and 46 focus the light in the beam 41 that is passed through the adjustable iris 47 onto the active surface of the substrate. The projection optics 44 and the beam splitter 32 are arranged so that the light deflected by the micromirror array away from the main optical axis (the central axis of the projection optics 44 to which the beams 41 are parallel), illustrated by the beams labeled 40 (e.g., 10° off axis) fall outside the entrance pupil of the projection optics 44 (typically 0.5/5=0.1; 10° corresponds to an aperture of 0.17, substantially greater than 0.1). The iris 47 is used to control the effective numerical aperture and to ensure that unwanted light (particularly the off-axis beams 40) is not transmitted to the substrate. Resolution of dimensions as small as 0.5 microns can be obtained with such optics systems. For manufacturing applications, it is preferred that the micromirror array 35 be located at the object focal plane of a lithographic I-line lens optimized for 365 nm. Such lenses typically operate with a numerical aperture (NA) of 0.4 to 0.5, and have a large field capability

The micromirror array device 35 may be formed with a single line of micromirrors (e.g., with 2,000 mirror elements in one line) which is stepped in a scanning system. In this manner, the height of the image is fixed by the length of the line of the micromirror array, but the width of the image that may be projected onto the substrate 12 is essentially unlimited. By moving the stage 18 which carries the substrate 12, the mirrors can be cycled at each indexed position of the substrate to define the image pattern at each new line that is imaged onto the substrate active surface.

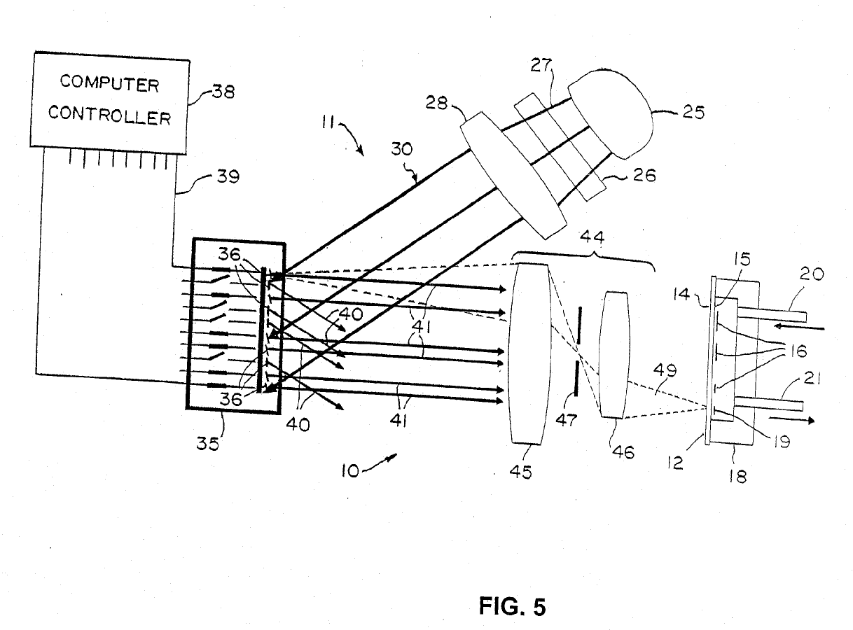

Another form of the array synthesizer apparatus 10 is shown in a simplified schematic view in FIG. 5. In this arrangement, the beamsplitter 32 is not used, and the light source 25, optional filter 26, and condenser lens 28 are mounted at an angle to the main optical axis (e.g., at 20° to the axis) to project the beam of light 30 onto the array of micromirrors 36 at an angle. The micromirrors 36 are oriented to reflect the light 30 into off-axis beams 40 in a first position of the mirrors and into beams 41 along the main axis in a second position of each mirror. In other respects, the array synthesizer of FIG. 5 is the same as that of FIG. 4.

For the purposes of this disclosure and unless otherwise specified, “a” or “an” means “one or more.” All patents, applications, references, and publications cited herein are incorporated by reference in their entirety to the same extent as if they were individually incorporated by reference.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,”“less than,” and the like includes the number recited and refers to ranges that can be subsequently broken down into subranges as discussed above. Finally, as will be understood by one skilled in the art, a range includes each individual member.

It is understood that the invention is not confined to the particular embodiments set forth herein as illustrative, but embraces all such modified forms thereof as come within the scope of the following claims.

What is claimed is:

1. A microwell array comprising:
(a) a substrate having a first surface and a second surface;
(b) an array of microwells comprising a plurality of microwells extending into the first surface, each microwell having a top opening and a bottom aperture that has a smaller diameter than the top opening and that extends through to the second surface of the substrate; and
(c) one or more carrier particles contained within the microwells.

2. The microwell array of claim 1, wherein each microwell contains only a single carrier particle.

3. The microwell array of claim 1, wherein the carrier particles comprise glass.

4. The microwell array of claim 1, wherein the microwells have volumes of no more than about 100 nL.

5. The microwell array of claim 4, wherein the microwells have a density on the first surface of at least 1000 microwells per square centimeter.

6. The microwell array of claim 1, wherein the bottom aperture opens into a well extending into the second surface of the substrate and facing opposite the microwell.

7. The microwell array of claim 1, wherein the bottom aperture is coated with a hydrophobic material.

8. The microwell array of claim 1, wherein the top openings of the microwells have a diameter of no more than about 250 microns.

9. A system for fabricating chain molecules on carrier particles comprising:
(a) the microwell array of claim 1; and
(b) a spatial light modulator positioned to project a light imaging having a selected pattern onto the microwell array.

10. The system of claim 9, wherein the spatial light modulator comprises a light source, a micromirror array onto which light from the light source is directed, and projection optics capable of projecting a light image reflected from the micromirror array onto the microwell array.

11. The system of claim 9, further comprising a flow cell housing the microwell array.

12. The system of claim 11, further comprising a nucleotide synthesizer in fluid communication with an import port in the flow cell.

13. A method for growing chain molecules on carrier particles having protected reactive functional groups on their surfaces, the method comprising:
(a) projecting a light image onto the microwell array of claim 1, such that only selected microwells are illuminated by light, wherein protected functional groups on the carrier particles in those microwells are photodeprotected; and
(b) exposing the photodeprotected carrier particles to a reagent comprising building block molecules that bind to the photodeprotected carrier particles.

14. The method of claim 13, further comprising:
(a) subsequently exposing the carrier particles to a reagent comprising a protecting agent to re-protect the reactive functional groups on the carrier particles and/or any unprotected functional groups on the carrier particle-bound building block molecules;
(b) projecting a new light image onto the microwell array, such that only selected microwells are illuminated by light, wherein protected functional groups on the carrier particles and/or the carrier particle-bound building block molecules are photodeprotected; and
(c) exposing the photodeprotected carrier particles to a reagent comprising a building block molecule that binds to the photodeprotected carrier particles or the photodeprotected carrier particle-bound building block molecules.

15. The method of claim 13, wherein the building block molecules comprise nucleotides and the chain molecules comprise oligonucleotides.
